(19) United States
(12) Patent Application Publication
(10) Pub. No.: US 2005/0182611 A1
(43) Pub. Date: Aug. 18, 2005

(54) Apparatus and method for simulating performance, and computer product

(75) Inventor: Mariko Sakamoto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/103,471

(22) Filed: Apr. 12, 2005

Related U.S. Application Data
(63) Continuation of application No. PCT/JP02/13251, filed on Dec. 18, 2002.

(51) Int. Cl. G06F 17/50

(52) U.S. Cl. 703/13

(57) ABSTRACT

A performance simulation apparatus that simulates operations of a computer, and collects and displays data that relates to dynamic conditions of hardware elements of the computer includes a graphic-data creating unit that creates graphic data for graphically displaying relationships between the dynamic conditions of the hardware elements; and a graphic-data displaying unit that displays the dynamic conditions of the hardware elements by using the graphic data that is created by the graphic-data creating unit.

### BACKGROUND OF THE INVENTION

1) Field of the Invention

The present invention relates to a technology for simulating operations of a computer to collect and display data that relates to dynamic conditions of hardware elements of the computer.

2) Description of the Related Art

Computer hardware designers use performance simulators to analyze and improve the performance of a computer. The performance simulators collect information that concerns dynamic conditions of hardware elements of the computer, such as buffers, queues, and selectors. Then the hardware designers consider ways of improving the computer performance based on the data collected by the performance simulators.

For example, the hardware designers use the performance simulator to collect data such as the numbers of accesses and misses in a cache, and request categories, and consider cache size, methods of writing to a memory, and the like, based on the collected data.

Computer performance analyzing techniques that uses such the performance simulator are disclosed in: Pradip Bose, and Thomas M. Conte, “Performance Analysis and Its Impact on Design,” IEEE Computer, May 1998, pp 41-49; S. R. Kunkel et al., “A performance methodology for commercial servers,” IBM J. Res. & Dev., Vol. 44, no. 6, pp. 851-872, November 2000.; Matt Reilly, and John Edmondson, “Performance Simulation of an Alpha Microprocessor,” IEEE Computer, May 1998, pp. 50-58; and Steven Kunkel, Bill Armstrong, and Philip Vitale, “System Optimization for OLTP Workloads,” IEEE Micro, May/June 1999, pp. 56-64.

However, the conventional performance simulator separately displays information that indicates dynamic conditions of hardware elements of the computer, as local information. As a result, it is difficult for the hardware designers to determine the relationship between the hardware elements and the operations of the entire computer, and the mutual relationships between the hardware elements, only from the local information.

Therefore, although locations of performance bottlenecks can be found from the local information, the real causes of the bottlenecks cannot easily be identified.

Particularly, in computers that have complex memory access, such as on-chip multiprocessors (CMP) and computers that have a multi-strand configuration, many factors affect its performance, so that it is not easy to determine overall relationships from locally displayed information, making it difficult to consider ways of improving the performance. A CMP is a computer in which a plurality of central processing units (CPU) share a memory, and one CPU may sometimes have a plurality of processors known as cores. In a multi-strand computer, one CPU simultaneously executes a plurality of jobs (strands).

### SUMMARY OF THE INVENTION

It is an object of the present invention to at least solve the problems in the conventional technology.

According to one aspect of the present invention, a performance simulation apparatus that simulates operations of a computer, and collects and displays data that relates to dynamic conditions of hardware elements of the computer includes a graphic-data creating unit that creates graphic data for graphically displaying relationships between the dynamic conditions of the hardware elements; and a graphic-data displaying unit that displays the dynamic conditions of the hardware elements by using the graphic data that is created by the graphic-data creating unit.

According to another aspect of the present invention, a computer-readable recoding medium stores a performance simulation program that causes a first computer to simulate operations of a second computer, and collect and display data that relates to dynamic conditions of hardware elements of the second computer, and the performance simulation program causes the first computer to execute creating hardware-element-related graphic data for graphically displaying relationships between dynamic conditions of the hardware elements; and displaying the dynamic conditions of the hardware elements by using the hardware-element-related graphic data.

According to still another aspect of the present invention, a computer-readable recoding medium stores a performance simulation program that causes a first computer to simulate operations of a second computer, and collect and display data that relates to dynamic conditions of hardware elements of the second computer, and the performance simulation program causes the first computer to execute creating hardware-element-related graphic data for graphically displaying relationships between dynamic conditions of the hardware elements; and transmitting the hardware-element-related graphic data via a network to a display device, the display device displaying the dynamic conditions of the hardware elements by using the hardware-element-related.

According to still another aspect of the present invention, a computer-readable recoding medium stores a performance simulation program that causes a first compute simulate operations of a second computer, and collect and display data that relates to dynamic conditions of hardware elements of the second computer, and the performance simulation program causes the first computer to execute creating hardware-element-related graphic data for graphically displaying relationships between dynamic conditions of the hardware elements; and outputting the hardware-element-related graphic data that is inputted from a display device to a storage device, the display device displaying the dynamic conditions of the hardware elements by using the hardware-element-related graphic data.

According to still another aspect of the present invention, a performance simulation method that simulates operations of a computer, and collects and displays data that relates to dynamic conditions of hardware elements of the second computer includes creating hardware-element-related graphic data for graphically displaying relationships between dynamic conditions of the hardware elements; and displaying the dynamic conditions of the hardware elements by using the hardware-element-related graphic data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for explaining a concept of dynamic data collection by a performance simulation apparatus according to an embodiment of the present invention;

FIG. 2 is a block diagram of the performance simulation apparatus according to the embodiment;

FIG. 3 is an example of simulation parameters for graphic display; FIG. 4 is a flowchart of a processing procedure of the performance simulation apparatus according to the embodiment;

FIG. 5 is a flowchart of a processing procedure of a graphic display data creator shown FIG. 2;

FIG. 6 is one example of a graphic display made by the performance simulation apparatus according to the embodiment;

FIG. 7 is another example of a graphic display made by the performance simulation apparatus according to the embodiment;

FIG. 8 depicts a computer system that executes a performance simulation program according to the embodiment; and

FIG. 9 is a schematic of a main unit shown in FIG. 8.

### DETAILED DESCRIPTION

Exemplary embodiments of the present invention will be explained in detail with reference to the accompanying drawings.

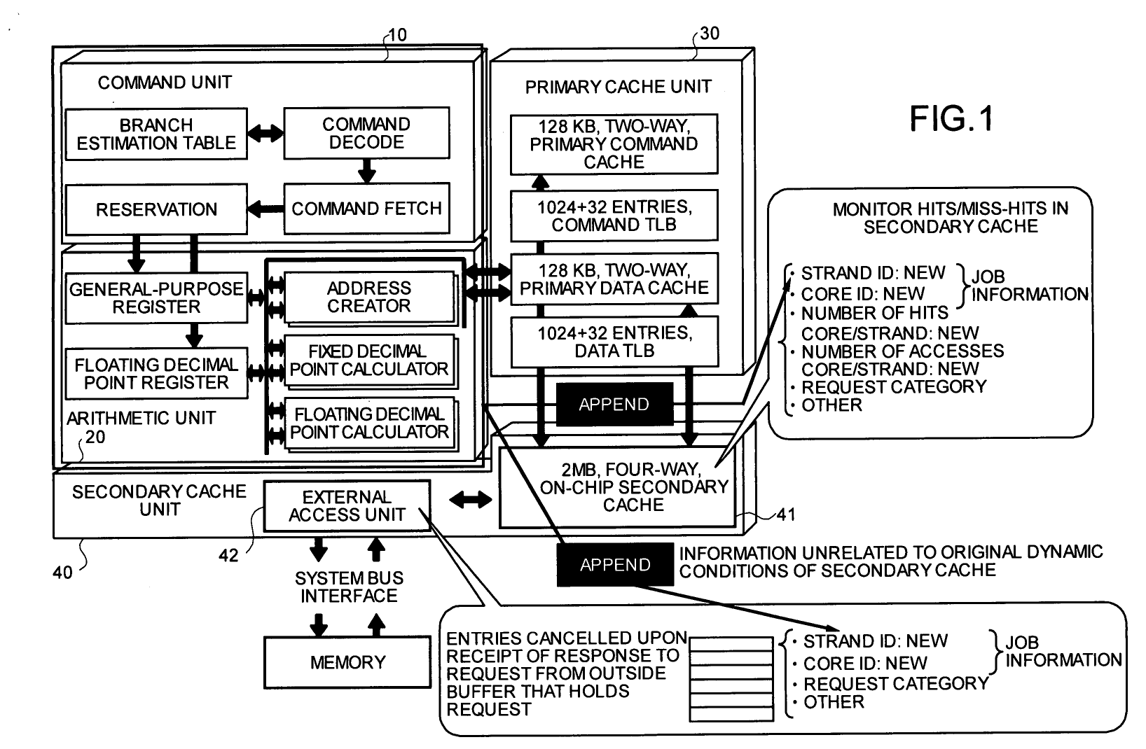

FIG. 1 is a schematic for explaining a concept of dynamic data collection by a performance simulation apparatus according to an embodiment of the present invention.

FIG. 1 is an example of a computer simulated by the performance simulation apparatus according to the embodiment. The computer includes a command unit 10, an arithmetic unit 20, a primary cache unit 30, and a secondary cache unit 40. The secondary cache unit 40 has a secondary cache 41 and an external access unit 42.

Conventional performance simulation apparatuses collect dynamic data, i.e., data that indicates dynamic conditions of buffers, queues, and selectors in these units, and display the collected dynamic data as local information. For example, for the secondary cache 41, dynamic data, such as the number of accesses, the number of hits, and request categories, is collected, and for the memory system between the secondary cache 41 and the memory, dynamic data, such as the number of send-out waits and the number of data waits of the buffer in the external access unit 42, is collected.

In contrast, the performance simulation apparatus according to the embodiment collects dynamic data that concerns the buffers, the queues, and the selectors of the units, and graphically displays dynamic conditions of the buffers, the queues, and the selectors, from the arithmetic unit to the memory, on the same time axis. When collecting the dynamic data of the buffers, the queues, and the selectors of the units, the performance simulation apparatus of the embodiment appends dynamic information of the entire computer to the collected dynamic data. Thus, the collected dynamic data can be graphically displayed in correlation with the operations of the entire computer.

For example, with respect to dynamic data that relates to the numbers of accesses and the number of hits in the secondary cache 41, a core ID is provided for identifying the command unit 10 and the arithmetic unit 20 of each core, and core ID and strand ID are appended to the collected data, therefore, the dynamic data can be graphically displayed separately for each core and strand, which correspond to sources of access requests to the secondary cache 41.

With respect to the memory system between the secondary cache 41 and the memory, the core ID and the strand ID are appended at the time of collecting data that concerns dynamic data such as the numbers of send-out waits and data waits of the buffer in the external access unit 42, therefore, the dynamic data can be graphically displayed separately for each core and strand that requested a memory access.

Thus, the performance simulation apparatus of the embodiment does not display the dynamic data that concerns the buffers, the queues, and the selectors, which are collected by executing a simulation, as local information, but displays the dynamic data graphically for each buffer, each queue, and each selector, from the arithmetic unit 20 to the memory. Therefore, the hardware designers can easily determine the relationships between them.

When collecting the dynamic data of the buffers, the queues, and the selectors of the units, the performance simulation apparatus of the embodiment appends the core ID and the strand ID, so that the dynamic conditions of the buffers, the queues, and the selectors can be displayed for each core and strand. Therefore, the hardware designers can easily determine the relationships between the dynamic conditions of the buffers, the queues, and the selectors, and the operations of the entire computer.

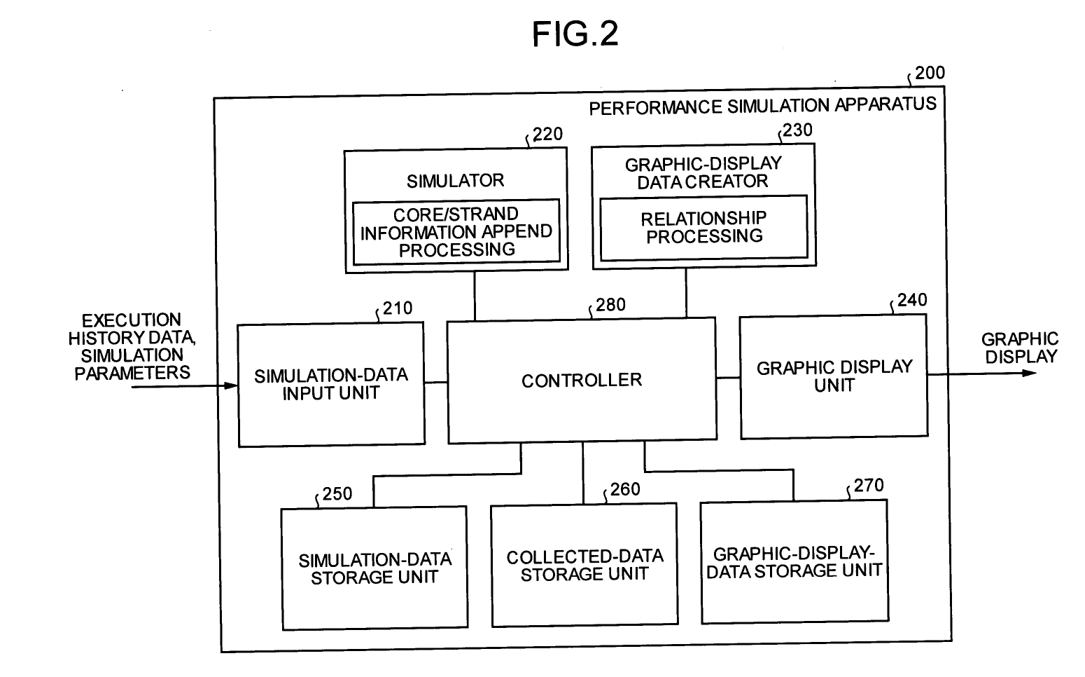

FIG. 2 is a block diagram of a performance simulation apparatus 200 according to the embodiment. The performance simulation apparatus 200 includes a simulation-data input unit 210, a simulator 220, a graphic-display data creator 230, a graphic display unit 240, a simulation-data storage unit 250, a collected-data storage unit 260, a graphic-display-data storage unit 270, and a controller 280.

The simulation-data input unit 210 is used to input execution history data and simulation parameters. Execution history data corresponds to a program executed by the computer to be simulated, and is history data when the program is executed by actual hardware. Instead of the execution history data, data corresponding to programs executed by the computer to be simulated may be data for simulation that inherits the trends of a program, data obtained by processing execution history data, or a program inputted by actual hardware.

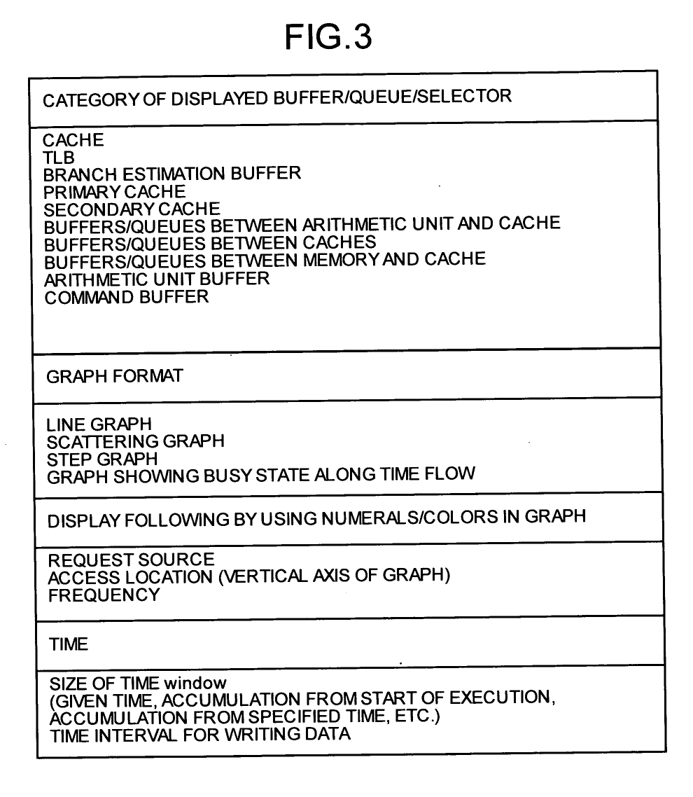

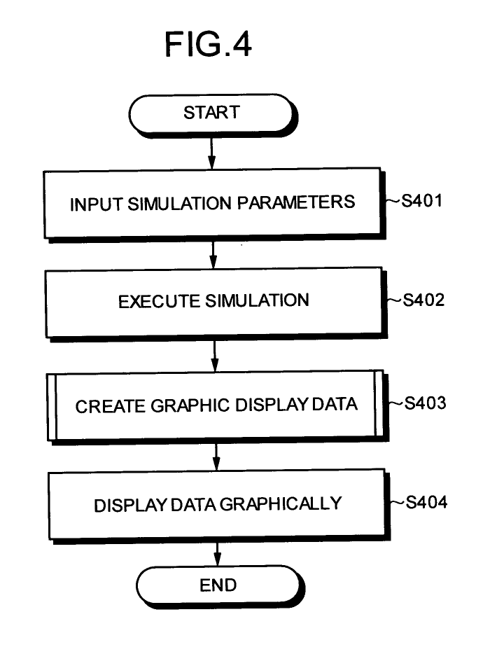

Simulation parameters are used for selecting specifications for executing simulation, used for specifying graphic display forms of simulation results, and the like. FIG. 3 is an example of simulation parameters for graphic display. As shown in FIG. 3, categories of buffers, queues, and selectors, graph forms, details of graph displays, and display times can be specified by using these simulation parameters.

The simulator 220 executes a simulation by using the simulation parameters inputted by the simulation-data input unit 210, and collects data that indicates dynamic conditions of the buffers, the queues, and the selectors. When collecting the data that indicates the dynamic conditions of the buffers, the queues, and the selectors, the simulator 220 appends information that relates to jobs that request access to the buffers, the queues, and the selectors, that is, appends the core ID and the strand ID, to the collected data.

The graphic-display data creator 230 creates graphic display data in the format specified by the simulation parameters, based on the data that indicates dynamic conditions of the buffers, the queues, and the selectors, collected by the simulator 220. At this time, the graphic-display data creator 230 creates display data so that the dynamic conditions of the buffers, the queues, and the selectors, from the arithmetic unit to the memory, can be graphically displayed on the same time axis. The graphic-display data creator 230 also creates display data so as to graphically display data for each core and strand that requests access to the buffers, the queues, and the selectors.

Thus, the graphic-display data creator 230 creates graphic display data that relates to dynamic conditions of the buffers, the queues, and the selectors, from the arithmetic unit to the memory, so that the hardware designers can easily determine the relationships between local dynamic data of the hardware elements.

When collecting data that indicates the dynamic conditions of the buffers, the queues, and the selectors, the simulator 220 appends information that relates to cores and strands that requested access to the buffers, the queues, and the selectors, and the graphic-display data creator 230 thereby creates graphic display data for each core and each strand. Consequently, the hardware designers can easily determine complex operations of a CMP or a computer that has a multi-strand configuration.

The graphic display unit 240 graphically displays the dynamic conditions of the buffers, the queues, and the selectors, on a display device, by using the graphic display data created by the graphic-display data creator 230.

The simulation-data storage unit 250 stores data that is required for the simulation and that is inputted by the simulation-data input unit 210, and is used by the simulator 220.

The collected-data storage unit 260 stores data that indicates the dynamic conditions of the buffers, the queues, and the selectors, collected by the simulator 220, and is used by the graphic-display data creator 230.

The graphic-display-data storage unit 270 stores graphic display data created by the graphic-display data creator 230. The graphic display unit 240 graphically displays data on the display device by using the graphic display data stored in the graphic-display-data storage unit 270.

The controller 280 controls the entire of the performance simulation apparatus 200. Specifically, the controller 280 makes the performance simulation apparatus 200 function as a single apparatus by passing the controls between its functional parts, passing data between the functional parts and the storage units, and the like.

FIG. 4 is a flowchart of a processing procedure of the performance simulation apparatus 200 according to the embodiment. At step S401, the simulation parameters are inputted to the performance simulation apparatus 200 via the simulation-data input unit 210. At step S402, based on the specifications of the simulation parameters that are inputted, the simulator 220 executes a simulation by using the execution history data, and collects data that indicates the dynamic conditions of the buffers, the queues, and the selectors. The simulator 220 appends IDs of the cores and the strands that requested access to the buffers, the queues, and the selectors, to the collected data.

At step S403, the graphic-display data creator 230 creates graphic display data based on the data that is collected. At this time, the graphic-display data creator 230 creates display data so that the dynamic conditions of the buffers, the queues, and the selectors, from the arithmetic unit to the memory, can be graphically displayed on the same time axis. The graphic-display data creator 230 creates graphic display data so that the dynamic conditions of the buffers, the queues, and the selectors can be displayed in correlation with the operations of the entire computer, by displaying them for each core and each strand, and the like. At step S404, the graphic display unit 240 graphically displays data on the display device by using the graphic display data that is created.

Thus, the graphic-display data creator 230 creates graphic display data so that the dynamic conditions of the buffers, the queues, and the selectors, from the arithmetic unit to the memory, can be displayed on the same time axis, and in correlation with the operations of the entire computer, and the graphic display unit 240 graphically display data on the display device by using the graphic display data that is created. Therefore, hardware designers can easily determine mutual relationships between the local dynamic data of the hardware elements.

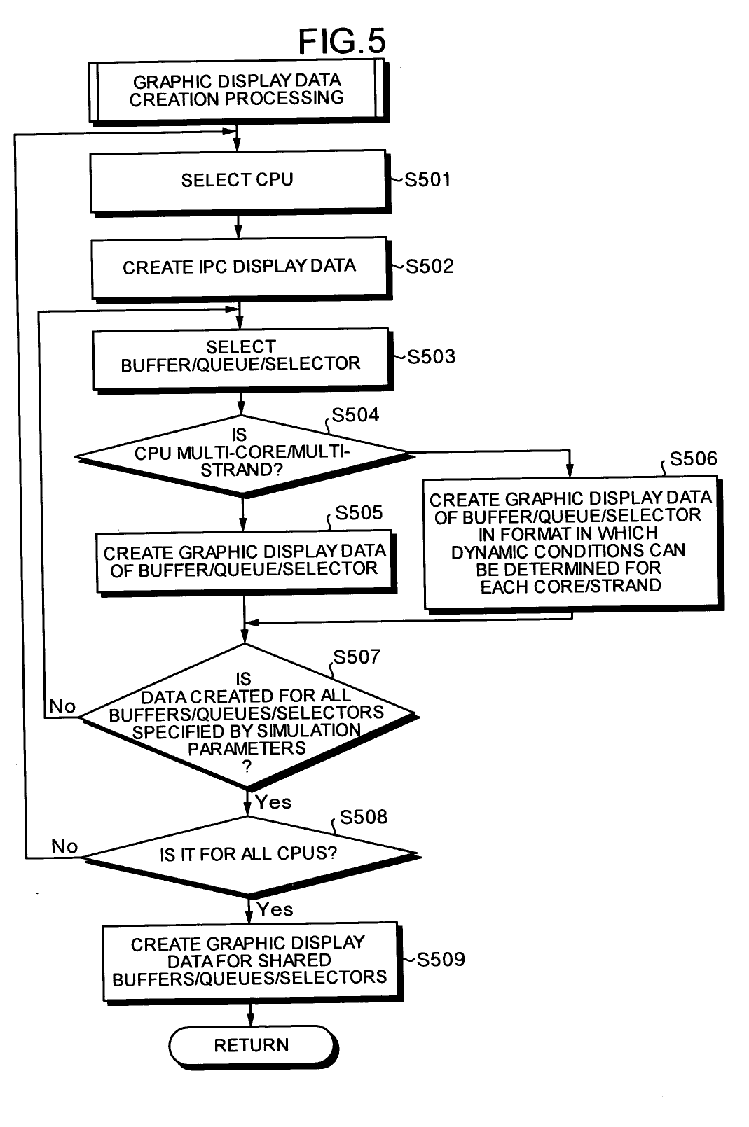

FIG. 5 is a flowchart of a processing procedure of the graphic-display data creator 230 shown FIG. 2. The processing of the graphic-display data creator 230 corresponds to the processing, of creating graphic display data, at the step S403 shown in FIG. 4.

The graphic-display data creator 230 selects one CPU at step S501, and creates instruction-per-cycle (hereinafter, “IPC”) graphic-display data with respect to the CPU that is selected, at step S502. The graphic-display data creator 230 then selects one buffer, queue, or selector, to be graphically displayed at step S503, and determines whether the CPU has a multi-core or a multi-strand configuration at step S504.

When the CPU has neither the multi-core nor the multi-strand configuration, the graphic-display data creator 230 creates graphic display data for the buffer that is selected, the queue that is selected, or the selector that is selected, at step S505. The format of the graphic display is specified by the simulation parameters.

On the other hand, when the CPU has the multi-core configuration or the multi-strand configuration, the graphic-display data creator 230 creates graphic display data in a display format where the dynamic conditions of the buffer that is selected, the queue that is selected, or the selector that is selected, can be determined for each core or each strand, at step S506. A display format where the dynamic conditions can be determined for each core or each strand can be achieved by changing the format and color of the graph for each core or each strand, and the like.

It is then determined, at step S507, whether graphic display data is created for all the buffers, all the queues, and all the selectors, which are specified in the simulation parameters. If not, processing returns to the step S503 and graphic display data is created for the other buffers, the other queues, and the other selectors. When graphic display data is created for all the buffers, all the queues, and all the selectors, which are specified in the simulation parameters, it is determined, at step S508, whether graphic display data has been created for all the CPUs. If not, processing returns to the step S501 and graphic display data is created for the other CPUs.

When graphic display data is created for all the CPUs, graphic display data is created for the buffers, the queues, and the selectors, that are shared with all the CPUs, at step S509, and processing ends. The graphic display data of the buffers, the queues, and the selectors, which are shared with all the CPUs, is created in a format where the dynamic conditions can be determined for each CPU.

Thus, when the CPU has the multi-core configuration or the multi-strand configuration, the graphic-display data creator 230 creates graphic display data in a display format where the dynamic conditions of the buffers, the queues, and the selectors can be determined for each core and each strand, whereby the performance simulation apparatus 200 can graphically display data that enables easily determining operations of a computer where memory access is complex, such as a CMP or a multi-strand configuration.

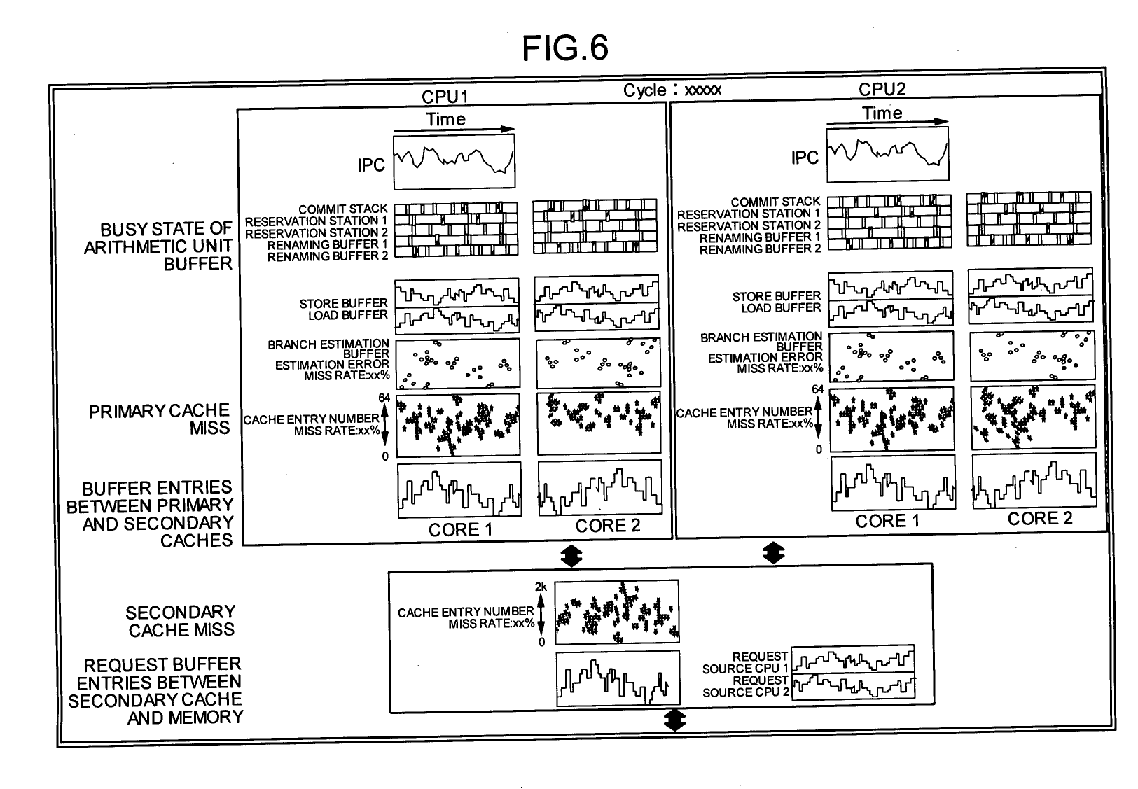

FIG. 6 is one example of a graphic display made by the performance simulation apparatus 200 according to the embodiment. In the example shown in FIG. 6, dynamic conditions of the buffers, the queues, and the selectors, from the arithmetic unit to the memory, in a simulated computer, are displayed on the same time axis, and the simulated computer includes a CMP configuration that has two CPUs, each having two cores.

As shown in FIG. 6, dynamic conditions of the buffers, the queues, and the selectors, from the arithmetic unit to the memory, are corresponding to busy states of the arithmetic unit, primary cache misses, and buffer entries between primary and secondary caches, and they are displayed for each core of the CPUs. Dynamic conditions of the buffers that are shared with the CPUs are corresponding to secondary cache misses and request buffer entries between the secondary cache and the memory, the latter being displayed for each CPU.

By graphically displaying the dynamic conditions of the buffers, the queues, and the selectors, from the arithmetic unit to the memory, on the same time axis in this way, the hardware designers can intuitively determine the relationships between the operations of the entire computer and the dynamic conditions of the buffers, the queues, and the selectors, enabling the hardware to be designed efficiently. By graphically displaying the dynamic conditions of the buffers, the queues, and the selectors for each CPU and each core, the hardware designers can efficiently design a computer system that has a CMP configuration.

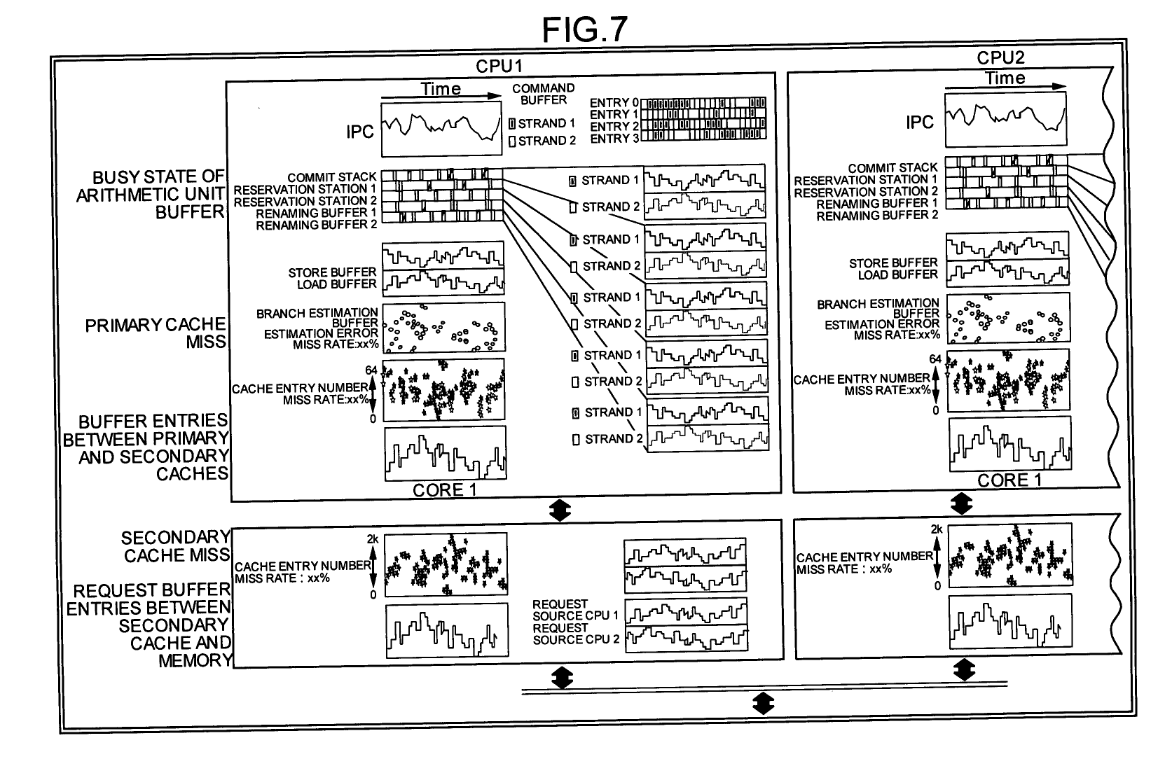

FIG. 7 is another example of a graphic display made by the performance simulation apparatus 200 according to the embodiment. It is an example of displaying dynamic conditions of the buffers, the queues, and the selectors, when simulating a computer in which one of a plurality of CPUs executes two strands.

As shown in FIG. 7, the dynamic conditions of a command buffer and an arithmetic unit buffer are graphically displayed for each strand, so that the hardware designers can efficiently design a computer system that has a multi-strand configuration.

As described above, in the embodiment, the simulator 220 collects data that indicates dynamic conditions of the buffers, the queues, and the selectors, the graphic-display data creator 230 creates data that graphically displays the dynamic conditions of the buffers, the queues, and the selectors, from the arithmetic unit to the memory, on the same time axis, and the graphic display unit 240 makes a graphic display on a display device by using the data that is created. Therefore, the hardware designers can intuitively determine the relationship between the operations of the entire computer and the dynamic conditions of the buffers, the queues, and the selectors, thereby facilitating determination of locations and causes of the phenomena that lower the performance.

In the embodiment, the simulator 220 appends core information and strand information to the data that indicates dynamic conditions of the buffers, the queues, and the selectors, the graphic-display data creator 230 creates graphic display data in a format where the dynamic conditions of the buffers, the queues, and the selectors can be identified for each core and each strand, and the graphic display unit 240 makes a graphic display on a display device by using the data that is created. Therefore, the hardware designers can efficiently design a computer system that has complex memory access, such as a CMP or a multi-strand configuration.

The respective components of the performance simulation apparatus 200 as shown in the figures are conceptual functions, and the physically same configuration is not always necessary. In other words, the specific arrangement obtained by separation or integration of the performance simulation apparatus 200 is not limited by the arrangements in the figures, and all or a part of the performance simulation apparatus 200 may be functionally or physically separated or integrated as arbitrary units, according to the various kinds of load and the status of use. For example, the graphic display unit 240 that makes a graphic display on a display device need not be provided in the performance simulation apparatus-200, and can be provided with a display device to another device that is connected via a network.

Simulation results need not be displayed immediately. For example, the graphic display data created by the graphic-display data creator 230 can be stored on a magnetic disk or the like before ending simulation processing, and the simulation results can be graphically displayed at another time.

While the performance simulation apparatus is taken as an example in the embodiment, a performance simulation program that has similar functions can be obtained by using software to realize the configuration of the performance simulation apparatus. A computer system that executes this performance simulation program will be explained.

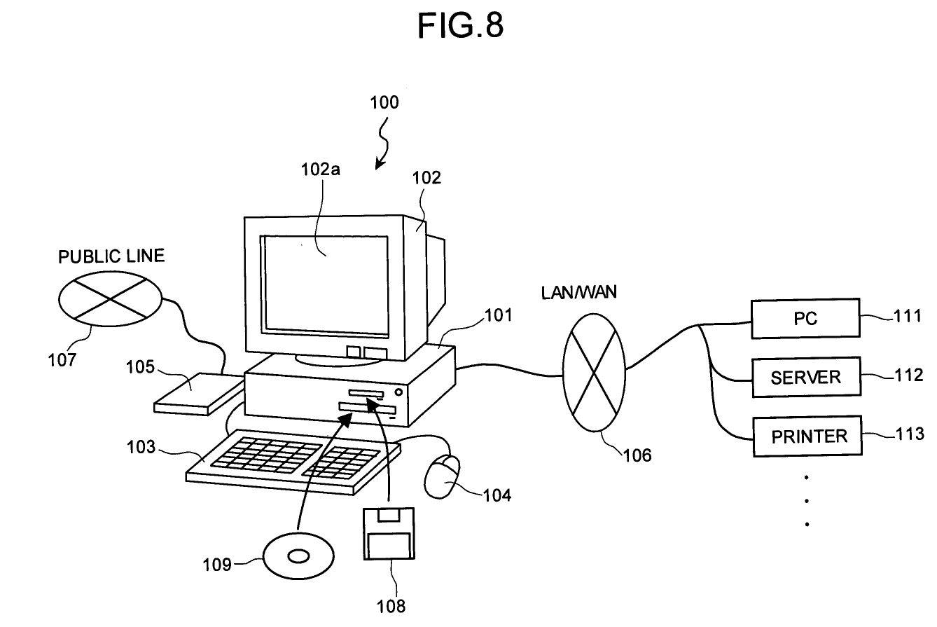

FIG. 8 depicts a computer system that executes a performance simulation program according to the embodiment. A computer system 100 includes a main unit 101, a display device 102 that displays information such as images on a display screen 102a based on an instruction from the main unit 101, a keyboard 103 for inputting various types of information to the computer system 100, a mouse 104 for specifying a given position on the display screen 102a of the display device 102, a local area network (LAN) interface that is connected to a LAN 106 or a wide area network (WAN), and a modem 105 that is connected to a public line 107 such as the Internet. The LAN 106 connects the computer system 100 to another computer system (personal computer (PC)) 111, a server 112, a printer 113, and the like.

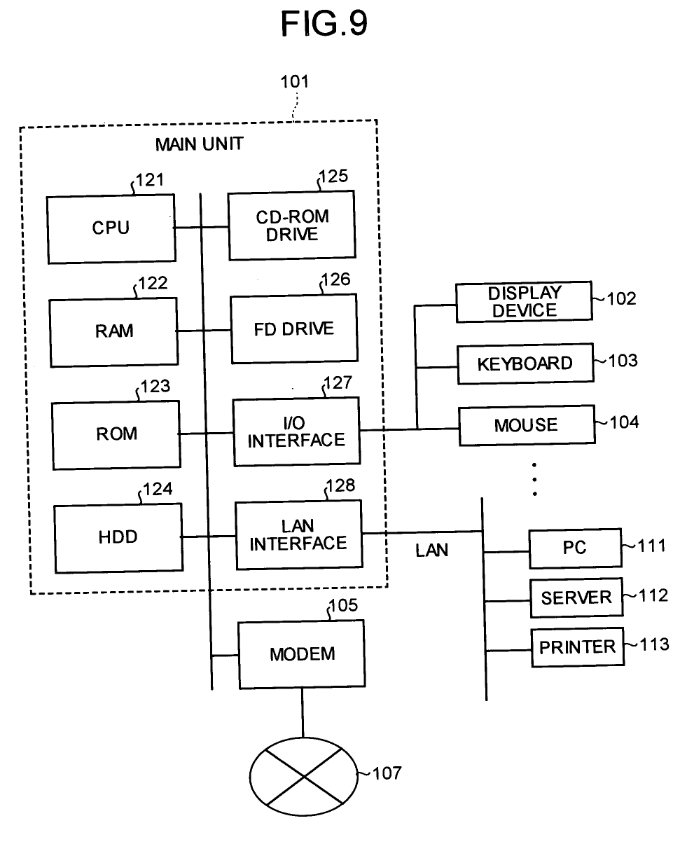

FIG. 9 is a schematic of the main unit 101. The main unit 101 has a CPU 121, a random access memory (RAM) 122, a read only memory (ROM) 123, a hard disk drive (HDD) 124, a CD-ROM drive 125, a floppy disk (FD) drive 126, an I/O interface 127, and a LAN interface 128.

When executing a performance simulation program in the computer system 100, a performance simulation program that is stored in a portable recording medium such as an FD 108, a CD-ROM 109, a digital versatile disk (DVD), an optical magnetic disk, or an IC card, a database of the other computer system (PC) 111 or the server 112 connected via the LAN interface 128, or a database of another computer system connected via the public line 107, is installed in the computer system 100. The performance simulation program that is installed is stored in the HDD 124, and executed by the CPU 121 using the RAM 122, the ROM 123, and the like.

As described above, according to the present invention, graphic data for graphically displaying relationships between dynamic conditions of hardware elements is created, and the dynamic conditions of the hardware elements are displayed by using the graphic data that is created. Therefore, the hardware designers can easily determine locations and causes of the phenomena that lower the performance.

According to the present invention, graphic data for graphically displaying relationships between dynamic conditions of the hardware elements is created, and the graphic data that is created is transmitted via a network to the display device that displays the dynamic conditions of the hardware elements by using the graphic data. Therefore, the hardware designers who use the display device can easily determine locations and causes of the phenomena that lower the performance.

According to the present invention, graphic data for graphically displaying relationships between dynamic conditions of the hardware elements is created, and inputted to the display device that displays the dynamic conditions of the hardware elements by using the graphic data, and then, outputted to the storage apparatus. Therefore, the hardware designers who use the display device can easily determine locations and causes of the phenomena that lower the performance.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A performance simulation apparatus that simulates operations of a computer, and collects and displays data that relates to dynamic conditions of hardware elements of the computer, comprising:
a graphic-data creating unit that creates graphic data for graphically displaying relationships between the dynamic conditions of the hardware elements; and
a graphic-data displaying unit that displays the dynamic conditions of the hardware elements by using the graphic data that is created by the graphic-data creating unit.

2. The performance simulation apparatus according to claim 1, wherein
the computer includes an arithmetic unit, and a memory,
the hardware elements of the computer include buffers, queues, and selectors, that are arranged along a transfer path of memory access data, access to the memory access data being requested by the arithmetic unit to the memory, and
the graphic-data creating unit creates graphic data for graphically displaying relationships between dynamic conditions of the buffers, the queues, and the selectors.

3. The performance simulation apparatus according to claim 2, wherein the graphic-data creating unit creates graphic data for graphically displaying dynamic conditions of the buffers, the queues, and the selectors, by using a shared time axis.

4. The performance simulation apparatus according to claim 2, further comprising a data collecting unit that collects the data while appending, to the data, information that relates to operations of whole of the computer, wherein
the graphic-data creating unit creates graphic data for graphically displaying relationships between the dynamic conditions of the buffers, the queues, and the selectors, and the operations of the whole of the computer, based on the data that is collected by the data collecting unit.

5. The performance simulation apparatus according to claim 4, wherein
the data collecting unit appends an identifier, as the information, to the data, the identifier corresponding to one of an identifier of each core and an identifier of each strand,
when the identifier corresponds to an identifier of each core, the graphic-data creating unit creates graphic data in a format where the dynamic conditions of the buffers, the queues, and the selectors can be identified for each core, by using the identifier appended, and
when the identifier corresponds to an identifier of each strand, the graphic-data creating unit creates graphic data in a format where the dynamic conditions of the buffers, the queues, and the selectors can be identified for each strand, by using the identifier appended.

6. The performance simulation apparatus according to claim 5, wherein
the computer further includes a first cache and a second cache,
the data collecting unit collects data that relates to dynamic conditions of buffers, queues, and selectors between the memory and the second cache, and buffers, queues, and selectors between the first cache and the second caches.

7. The performance simulation apparatus according to claim 5, wherein
when the performance simulation apparatus simulate a cache protocol, as one of the operations of the computer, the data collecting unit collects data that relates to cache misses and cache invalidates as data that relates to dynamic conditions of the first cache and the second cache.

8. The performance simulation apparatus according to claim 5, wherein
when the performance simulation apparatus simulates a branch estimation operation and a translation lookaside buffer (TLB) operation as the operations of the computer, the data collecting unit collects data that relates to creations of entries in a branch estimation buffer, hits or misses in the branch estimation buffer, creations of entries in a translation lookaside buffer (TLB), and hits and misses in the TLB, as data that relates to dynamic conditions of the TLB.

9. A computer-readable recoding medium that stores therein a performance simulation program that causes a first computer to simulate operations of a second computer, and collect and display data that relates to dynamic conditions of hardware elements of the second computer, the performance simulation program causing the first computer to execute:
creating hardware-element-related graphic data for graphically displaying relationships between dynamic conditions of the hardware elements; and
displaying the dynamic conditions of the hardware elements by using the hardware-element-related graphic data.

10. The computer-readable recoding medium according to claim 9, wherein
the computer includes an arithmetic unit and a memory,
the hardware elements includes buffers, queues, and selectors, that are arranged along a transfer path of memory access data, access to the memory access data being requested by the arithmetic unit to the memory, and
the creating the hardware-element-related graphic data includes creating specific-hardware-element-related graphic data for graphically displaying relationships between dynamic conditions of the buffers, the queues, and the selectors.

11. The computer-readable recoding medium according to claim 10, wherein
the creating specific-hardware-element-related graphic data includes creating time-axis-based graphic data for graphically displaying dynamic conditions of the buffers, the queues, and the selectors by using a shared time axis.

12. The computer-readable recoding medium according to claim 11, further causing the first computer to execute:
collecting the data;
appending, to the data, information that relates to operations of a whole of the second computer while the data is collected; and
creating collected-data-based graphic data for graphically displaying relationships between the dynamic conditions of the buffers, the queues, and the selectors, and operations of the whole of the second computer, based on the data collected in the collecting.

13. The computer-readable recoding medium according to claim 12, wherein
the appending includes appending an identifier, as the information, to the data, the identifier corresponding to one of an identifier of each core and an identifier of each strand,
when the identifier corresponds to an identifier of each core, the creating hardware-element-related graphic data includes creating graphic data in a format where the dynamic conditions of the buffers, the queues, and the selectors can be identified for each core by using the identifier appended in the appending, and
when the identifier corresponds to an identifier of each strand, the creating hardware-element-related graphic data includes creating graphic data in a format where the dynamic conditions of the buffers, the queues, and the selectors can be identified for each strand by using the identifier appended in the appending.

14. A computer-readable recoding medium that stores therein a performance simulation program that causes a first computer to simulate operations of a second computer, and collect and display data that relates to dynamic conditions of hardware elements of the second computer, the performance simulation program causing the first computer to execute:
creating hardware-element-related graphic data for graphically displaying relationships between dynamic conditions of the hardware elements; and
transmitting the hardware-element-related graphic data via a network to a display device, the display device displaying the dynamic conditions of the hardware elements by using the hardware-element-related.

15. The computer-readable recoding medium according to claim 14, wherein
the computer includes an arithmetic unit and a memory,
the hardware elements includes buffers, queues, and selectors, that are arranged along a transfer path of memory access data, access to the memory access data being requested by the arithmetic unit to the memory, and
the creating the hardware-element-related graphic data includes creating specific-hardware-element-related graphic data for graphically displaying relationships between dynamic conditions of the buffers, the queues, and the selectors.

16. The computer-readable recoding medium according to claim 15, wherein
the creating specific-hardware-element-related graphic data includes creating time-axis-based graphic data for graphically displaying dynamic conditions of the buffers, the queues, and the selectors by using a shared time axis.

17. The computer-readable recoding medium according to claim 16, further causing the first computer to execute:
collecting the data;
appending, to the data, information that relates to operations of a whole of the second computer while the data is collected; and
creating collected-data-based graphic data for graphically displaying relationships between the dynamic conditions of the buffers, the queues, and the selectors, and operations of the whole of the second computer, based on the data collected in the collecting.

18. The computer-readable recoding medium according to claim 17, wherein
the appending includes appending an identifier, as the information, to the data, the identifier corresponding to one of an identifier of each core and an identifier of each strand,
when the identifier corresponds to an identifier of each core, the creating hardware-element-related graphic data includes creating graphic data in a format where the dynamic conditions of the buffers, the queues, and the selectors can be identified for each core by using the identifier appended in the appending, and
when the identifier corresponds to an identifier of each strand, the creating hardware-element-related graphic data includes creating graphic data in a format where the dynamic conditions of the buffers, the queues, and the selectors can be identified for each strand by using the identifier appended in the appending.

19. A computer-readable recoding medium that stores therein a performance simulation program that causes a first compute simulate operations of a second computer, and collect and display data that relates to dynamic conditions of hardware elements of the second computer, the performance simulation program causing the first computer to execute:
creating hardware-element-related graphic data for graphically displaying relationships between dynamic conditions of the hardware elements; and
outputting the hardware-element-related graphic data that is inputted from a display device to a storage device, the display device displaying the dynamic conditions of the hardware elements by using the hardware-element-related graphic data.

20. The computer-readable recoding medium according to claim 19, wherein
the computer includes an arithmetic unit and a memory,
the hardware elements includes buffers, queues, and selectors, that are arranged along a transfer path of memory access data, access to the memory access data being requested by the arithmetic unit to the memory, and
the creating the hardware-element-related graphic data includes creating specific-hardware-element-related graphic data for graphically displaying relationships between dynamic conditions of the buffers, the queues, and the selectors.

21. The computer-readable recoding medium according to claim 20, wherein
the creating specific-hardware-element-related graphic data includes creating time-axis-based graphic data for graphically displaying dynamic conditions of the buffers, the queues, and the selectors by using a shared time axis.

22. The computer-readable recoding medium according to claim 21, further causing the first computer to execute:
collecting the data;
appending, to the data, information that relates to operations of a whole of the second computer while the data is collected; and
creating collected-data-based graphic data for graphically displaying relationships between the dynamic-conditions of the buffers, the queues, and the selectors, and operations of the whole of the second computer, based on the data collected in the collecting.

23. The computer-readable recoding medium according to claim 22, wherein
the appending includes appending an identifier, as the information, to the data, the identifier corresponding to one of an identifier of each core and an identifier of each strand,
when the identifier corresponds to an identifier of each core, the creating hardware-element-related graphic data includes creating graphic data in a format where the dynamic conditions of the buffers, the queues, and the selectors can be identified for each core by using the identifier appended in the appending, and
when the identifier corresponds to an identifier of each strand, the creating hardware-element-related graphic data includes creating graphic data in a format where the dynamic conditions of the buffers, the queues, and the selectors can be identified for each strand by using the identifier appended in the appending.

24. A performance simulation method that simulates operations of a computer, and collects and displays data that relates to dynamic conditions of hardware elements of the second computer, comprising:
creating hardware-element-related graphic data for graphically displaying relationships between dynamic conditions of the hardware elements; and
displaying the dynamic conditions of the hardware elements by using the hardware-element-related graphic data.

25. The performance simulation method according to claim 24, wherein
the computer includes an arithmetic unit and a memory,
the hardware elements includes buffers, queues, and selectors, that are arranged along a transfer path of memory access data, access to the memory access data being requested by the arithmetic unit to the memory, and
the creating the hardware-element-related graphic data includes creating specific-hardware-element-related graphic data for graphically displaying relationships between dynamic conditions of the buffers, the queues, and the selectors.

26. The performance simulation method according to claim 25, wherein
the creating specific-hardware-element-related graphic data includes creating time-axis-based graphic data for graphically displaying dynamic conditions of the buffers, the queues, and the selectors by using a shared time axis.

27. The performance simulation method according to claim 25, further comprising:
collecting the data;
appending, to the data, information that relates to operations of a whole of the second computer while the data is collected; and
creating collected-data-based graphic data for graphically displaying relationships between the dynamic conditions of the buffers, the queues, and the selectors, and operations of the whole of the second computer, based on the data collected in the collecting.

28. The performance simulation method according to claim 27, wherein
the appending includes appending an identifier, as the information, to the data, the identifier corresponding to one of an identifier of each core and an identifier of each strand,
when the identifier corresponds to an identifier of each core, the creating hardware-element-related graphic data includes creating graphic data in a format where the dynamic conditions of the buffers, the queues, and the selectors can be identified for each core by using the identifier appended in the appending, and
when the identifier corresponds to an identifier of each strand, the creating hardware-element-related graphic data includes creating graphic data in a format where the dynamic conditions of the buffers, the queues, and the selectors can be identified for each strand by using the identifier appended in the appending.
